(19) United States
(12) Patent Application Publication
(10) Pub. No.: US 2024/0361610 A1
(43) Pub. Date: Oct. 31, 2024

(54) Lenticular Image Displays and Methods For Making

(71) Applicant: Daniel Bernard Kainen, New York, NY (US)

(72) Inventor: Daniel Bernard Kainen, New York, NY (US)

(21) Appl. No.: 18/307,688

(22) Filed: Apr. 26, 2023

(51) Int. Cl. G02B 30/29

(52) U.S. Cl. CPC G02B 30/29

(57) ABSTRACT

Methods for manufacturing lenticular, fly's eye, or other types of lens array-based image displays, using prints overlaid by, but not bonded to, a lens array, some incorporating motion of either lens array or image, and methods of ensuring critical printed image-to-lens array alignment in manufacture and during device operation are shown. These may take the form of an image display frame or hand-held viewer with interchangeable images, aligned manually and/or by optical sensor-driven servo actuators, a folding card, and other displays, which can show three- dimensional, and/or animated, and other types of images, as well as accommodate standard computer-printer printouts made with compatible software. Such a family of devices can be used as greeting, or novelty cards, educational or informational books, toys, advertising premiums, displays, including point-of-purchase, or art-pieces, which can be wall mounted and/or motor- driven.

### TECHNICAL FIELD

The present invention relates to lenticular image displays and methods of making and using to provide registration between lenticular lenses and image media.

### BACKGROUND OF THE INVENTION

Lenticular lens array technologies are well known. Since the 1950's, when plastic technologies became adaptable to use as lenses, lenticular images were laminated to plastic lens arrays. Later, printing in register on flexible lens arrays with high-speed presses, and even printing/embossing transparent lenses themselves in register over the interleaved images have been explored. Folding cards and books are known, but suffer from alignment problems because of inaccurate guidage techniques.

Ultraviolet cured bonding of lenticular images to lens arrays is also known, but has only been used to permanently bond image media to a lens, and not to allow reciprocal motion between image media and a lens array.

Cylindrical lenticular arrays are also well known, using both slits and lenses, and sometimes appearing in holographic form and called “360's”, wherein a lenticular array is created holographically at very high resolution, and gives the illusion of a three-dimensional object within the cylinder. Some amount of animation is possible, but suffers from blurring because of the binocular vision caused by vertical lenses.

U.S. Pat. No. 6,277,232 relates to a lenticular folding card, but does not disclose a way to obtain accurate registration of the lenticular lens array and image media.

### SUMMARY OF THE INVENTION

The current invention provides methods to align prints with a lens array in displays using unbonded, moveable prints and/or lens arrays. It also addresses the problem of wear on both the print and the lens array, where motion between them is involved.

The present invention provides methods for positioning a servo device to align the print and/or the lenticular screen, using an alignment mark or marks on the print. These marks can be detected optically both through the lens array, or outside of it, and the servo device can move either the lens array or the print to achieve alignment. These methods can be used in the manufacture of a replaceable image display frame, card, book, or cardcase, which, when opened, moves the print and/or the screen to achieve optical effects, including motion and three-dimensional images, and also can be used during the operation of the device by the user, such as in a replaceable image display frame.

The invention provides a method of ensuring print-to-lens array alignment, in which the user observes a register mark on the print through the lens array and moves the lens array by means of manual motion controls. The print may be moved, rather than the lens array. An optical sensor may be used to determine the position of one or more register marks on the print and adjust the position of the lens array to correspond to the print by means of a servo-controlled motion device. The printed image may be adjusted, rather than the lens array. The optical sensor may detect the register mark through the lens array itself. The optical sensor may detect the register mark outside of the lens array, or through a clear area of the lens array that has no lensing properties. The lens array may be rectangular and covers a print, extending beyond the print on opposing sides, and in which extended areas are bonded to a substrate, trapping the print between the array the substrate, but still allowing the print to move in a direction perpendicular to the axis of the bonded sides in the finished assembly. The adhesive may be cured with ultraviolet light, and may be time-cured. The lens array may be a moving scroll in front of a stationary printed image. The printed image may be a moving scroll behind a stationary lens array.

The invention provides an arrangement to reduce wear on the print and/or the lens array during reciprocal motion, by setting the focal distance of the lenses off the surface of the lens array, so that parallel planes of the print and array do not touch. The parallel plane of the lens array may rest on at least two equally raised areas, adjacent to at least two opposing sides of the print, and move above said print. A thin transparent silicon layer or scratch-resistant coating, such as Diamond Like Carbon (DLC) to the side of the lens array that would normally be in contact with the print, or to the print itself may be used.

The invention provides an arrangement to ensure a straight trajectory of a lens array and print during reciprocal motion, by applying a slight spring force on the side of a movable lens array, to press it against a straight edge, and in which the spring, and the opposite side's straight edge, only contact their respective components with a small area of contact to further reduce friction. A print may be carried by a platen and may be moved, rather than the lens array. The lens array may be guided by interlocking grooves and ridges made of a low-friction material such as Teflon, in order that they may grip each other with no play, or hysteresis. The print-carrying platen may be guided, rather than the lens array.

The invention provides an arrangement for assuring the straightness of the trajectory of a moving printed image overlaid by a lens array in a folding card of paper or plastic, with a main hinge between top and bottom flap, in which a third, smaller, image-carrying flap, is hinged to the top flap, along a parallel axis just above the main hinge of the card, such that the flap is pulled in the direction of the opening top flap, and underneath a lens array which is fixed to the bottom flap only on either side of the image-flap, allowing its motion perpendicular to them, and in which two small flaps are bent over the free end of the image-flap opposite its hinge, such that they guide the axis of the trajectory of the image-flap to be constantly parallel to its direction of motion. The lens array above the image-flap may be fixed on either horizontal side of the image-flap, to a stiff substrate beneath the image flap such as cardboard or chipboard or plastic, which itself is bonded to the bottom flap, and on which a thin cushion of compressible material such as plastic foam or paper towel, between the stiff substrate and the image-flap, ensures all-over contact between the print and its overlaying lens array.

The invention provides an arrangement for creating a horizontal lenticular display, in which a horizontally oriented, continuous array of lenses or slits which are not perfectly horizontal, but not noticeably so, are contained within a perfectly horizontal frame, such that the lenses are vertically displaced by one or more lens widths along their entire length, which is two or more times wider than an identically pitched and tilted lenticular image, which rides along the horizontal frame so as to maintain a perfectly parallel, horizontal motion, such that when reciprocal horizontal motion occurs between the image and the lens, the image seems to change or animate. The tilted and horizontally oriented, continuous lenses or slits may be formed into a cylinder, such that they are vertically displaced by one or more lens widths per rotation of the cylinder about its central z-axis, and in which an inner cylinder bears a print corresponding to the outer array, such that reciprocal motion between inner and outer cylinder causes its image to change or animate.

The invention provides a method of making a lenticular lens array image display, comprising providing a sheet of a certain width with pre-cut flap sections along its length including an image flap; an inner top flap hinged to the image flap, an outer top flap hinged to the inner top flap and a bottom flap hinged to the outer top flap, wherein the image flap contains an image area and a register mark in a strip extending along the width of the image flap, wherein the bottom flap contains a lenticular lens array and having adhesive strip areas at the peripheral edges; folding the image flap onto the inner top flap; folding the outer top flap onto the inner top flap; folding the bottom flap onto the outer top flap so that the image flap overlays the bottom flap; locating a lenticular lens array onto the bottom flap, aligning it with the register mark on the image flap, and adhering the lenticular lens array along edges corresponding to the adhesive strip areas whereby the lenticular lens array covers the image area, but wherein the image flap slides under the lenticular lens array when the inner and outer top faps hinges on the bottom flap to effect relative motion of the image area and lenticular lens array.

The width of the image flap may be less than the certain width of the inner top flap. The width of the lenticular lens array may be about the same width as the image flap. The method may further include providing punch out flaps at edges of the bottom flap for overlaying and aligning the image flap when the image flap slides under the lenticular lens array. The method may further include a wrap-around flap hinged to the bottom flap which covers the bottom flap but which defines a central opening enabling viewing of the image area through the lenticular lens array. The step of locating a lenticular lens array onto the bottom flap may comprise lifting a lenticular lens array from a supply stack of lenticular lens arrays; applying adhesive to two opposite edges of the lenticular lens array; aligning the lenticular lens array onto the bottom flap using the register mark and mounting the lenticular lens array onto the bottom flap; and curing the adhesive. The step of locating the lenticular lens array onto the bottom flap and aligning it with the register mark on the image flap may include using optical sensors which detect the position of the lenticular lens array and move it to obtain alignment. The step of locating a lenticular lens array onto the bottom flap may comprise lifting a lenticular lens array using a suction cup. The step of locating a lenticular lens array onto the bottom flap may comprise using an arm movable about from a first rotational position where it lifts a lenticular lens array from a supply stack, to a second position wherein the lenticular lens array receives adhesive, to a third position wherein the lenticular lens array is aligned with the bottom flap. The arm may rotate around a central axis to the first, second, and third positions. The step of curing may include curing with an ultraviolet (UV) curing flash lamp. The method may include having the first, second and third positions along a linear path.

The invention provides a lenticular lens array image display made according to the above-described method.

The invention provides a lenticular lens array image display, comprising: a housing with a back, bottom, front with lenticular lens array and a top hinged lid to which it is hinged to an upper part of the back, a platen attached to the lid and hinged by connected to the back, and defining an image medium storage region between the platen and front, whereby movement of the top hinged lid will cause the platen to move towards and away from the front with the lenticular lens array. The image medium storage region may have a size to hold a plurality of image media plates. The lenticular lens array image display may include manual adjustment knobs which are operative to shift an image media plate in the image medium storage region and align it using a register mark on a peripheral edge of the image media plate so that an image stored in the image media plate will be aligned with the lenticular lens array. The lenticular lens array display may further include servo adjust mechanisms and optical cells which detect the position of the image media plate relative to the lenticular lens array using a register mark, and shift the image media plate to be aligned with the lenticular lens array using the servo adjust mechanisms. The invention provides a lenticular lens array image display, comprising an inner cylinder containing lenticular images around the inner cylinder, and an outer cylinder of lenticular lens array arranged with lenses formed generally horizontally but at inclined angles and enclosing the inner cylinder, whereby rotation of inner and outer cylinders relative to each other will enable display of an animated image when viewed from a perspective outside the outer cylinder. The lenticular lens array image display may include a light source located inside the inner cylinder. The invention provides a lenticular lens array image display, comprising a generally rectangular frame having a front, back, and bottom defining slot for receiving an image plate containing a lenticular viewable image, and a lenticular lens array on the front of the frame, the lens array having a lenticular lens array which is slanted relative to the rectangular frame, whereby movement of the image plate from side to side within the frame will cause display of an animated image viewed from the front of the frame. The lenticular lens array may have one of slots and ridges, and wherein the image plate has the other of slots or ridges to guide the lenticular lens array relative to the image plate. The lenticular lens array may have at least one of the slots and ridges made of relatively low-friction material, such as Teflon.

The invention provides a lenticular lens array and image display, comprising: an image plate media for containing a plurality of interleaved lenticular images; and a lenticular lens array which overlays the image plate media, whereby relative motion of the image plate media and lenticular lens array enables animated images to be seen viewed through the lenticular lens array; wherein at least of the image plate media and lenticular lens array includes a registration mark to provide alignment of the image plate media with the lenticular lens array. The registration mark may be in the form of a registration strip on the image plate media.

### BRIEF DESCRIPTION OF THE DRAWINGS

FIG. 1 is a perspective view of a folding card according to an embodiment of the invention;

FIG. 2 is a perspective view similar to that of FIG. 1, but with a bottom envelope or cover over the bottom flap;

FIG. 2A is a plan view of a die-cut panel of the different flaps of FIGS. 1 and 2 before assembly;

FIG. 3A is a plan view of a rotatable, servo-controlled mechanism for picking up a lens array card, moving it to a station to apply adhesive, and then to a station for alignment and attachment to a folding card with ultra-violet (UV) curing of adhesive;

FIG. 3B is a plan view of mechanism for mounting a lens array onto a folding card similar to the arrangement of FIG. 3, but wherein the stations are along a linear path;

FIG. 4A is a front elevational view of a servo-controlled replaceable image picture display assembly of FIGS. 4 and 4A;

FIG. 4B is a front elevational view of an assembly similar to that of FIG. 4A, but with manually actuated registration instead of servo-actuated registration;

FIG. 4C is a side elevational view of a replaceable image picture frame assembly with a cushion platen showing movement of the front print being moved to the back of the stack;

FIG. 5A is a front elevational view of a flat or linear image display; and

FIG. 5B is a top view of the image display of FIG. 5A.

FIG. 6A is a front elevational view of an image display in the form of a cylinder; and

FIG. 6B is a top view of the display of FIG. 6A.

### DETAILED DESCRIPTION OF THE PREFERRED EMBODIMENTS

Detailed descriptions of preferred embodiments will be given, but the invention is not limited to these embodiments.

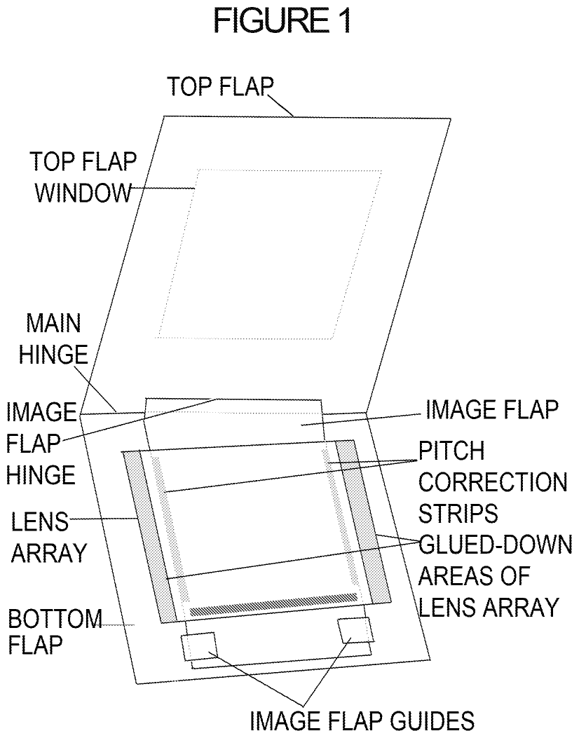

FIG. 1 shows a folding card of paper or plastic, with a main hinge between top and bottom flap, in which a third, smaller, image-carrying flap, is hinged to the top flap, along a parallel axis just above the main hinge of the card, such that the flap is pulled in the direction of the opening top flap, and underneath a lens array which is fixed to the bottom flap only on either side of the image-flap, allowing its motion perpendicular to them, and in which two small flaps are bent over the free end of the image-flap opposite its hinge, such that they guide the axis of the trajectory of the image-flap to be constantly parallel to its direction of motion.

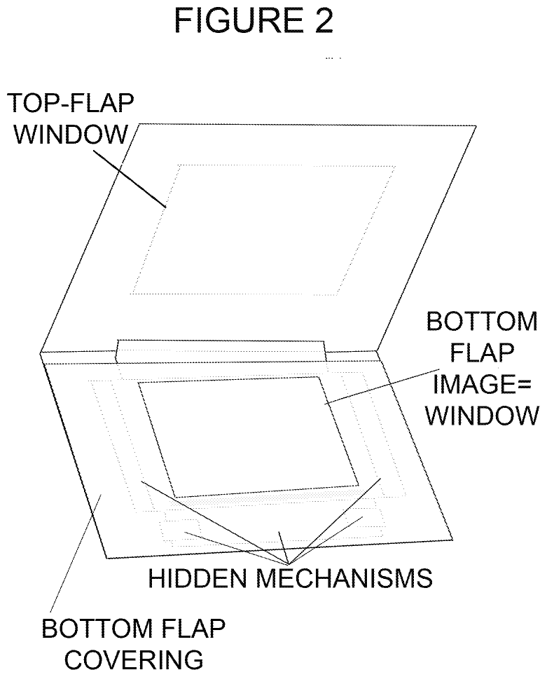

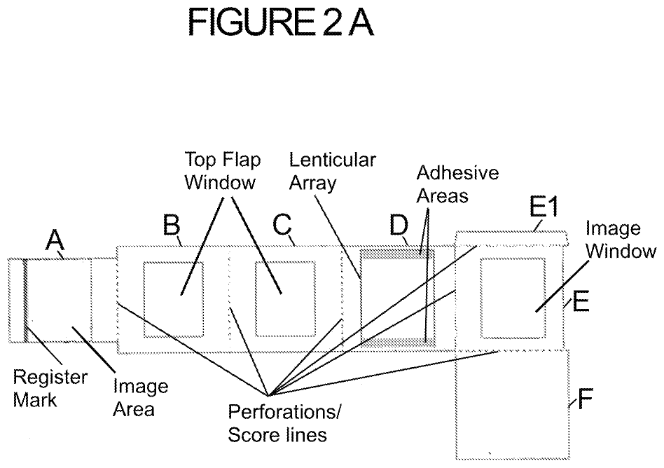

FIG. 2 shows the embodiment of FIG. 1, but also including a bottom envelope covers all mechanisms for the folding card's function, and reveals only the image area of the image-flap.

FIG. 2A shows the flap sections in a die-cut used to make the embodiment of FIGS. 1 and 2. The flaps are made of a continuous piece of material of paper, plastic, or other suitable material, with sections labeled A, B, C, D, E and F for identification purposes. Section A is the inner flap section of FIGS. 1 and 2. Section B is the inner top flap of FIGS. 1 and 2, which is the flap seen in these Figures. Section C is the panel layer of the outer top flap behind and adhered to the inner top flap section B. Sections B and C have a window cut-out which is optional. The cut-out could also be a clear transparent sheet. Section D is the bottom section E is the bottom envelope of FIG. 2 which is covering the bottom flap shown in FIG. 1. Section F is the very bottom layer which wraps around the bottom flap. The extra piece El of Section E wraps around section F.

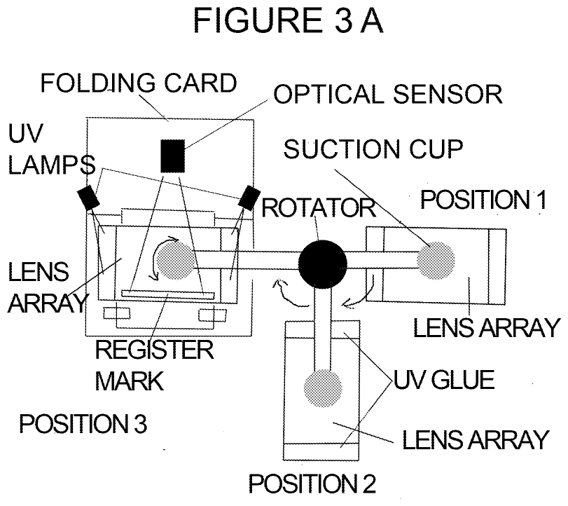

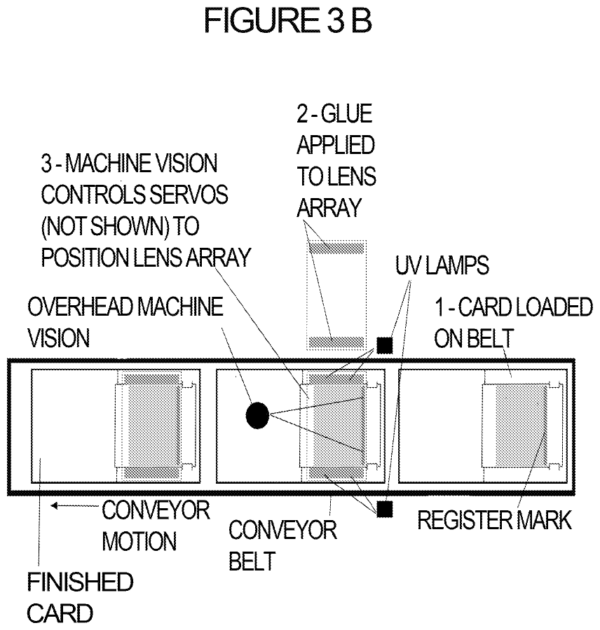

FIG. 3A shows a rotational assembly (which can also be linear), in which an arm with suction cup or other means of holding the rectangular lens array, picks up the lens array from a supply stack or the like and then positions it to receive adhesive on its peripheral edge areas which do not cover the image flap, and then positions it over the image on the image flap, rotating/translating it until an optical sensor determines that the lens array is perfectly aligned with the register mark on the image. An ultraviolet (UV) light source then cures the adhesive.

FIG. 3B is a plan view of a linear processing arrangement of a conveyer belt for locating and attaching a lenticular screen onto a folding strip on the peripheral edge of the image area. At position 1, a folding card is positioned onto a conveyer belt. The folding card has an image area with a register mark. At position 2, adhesive glue is applied to a lenticular screen. Servos not shown in FIG. 3B but similar to the servos in FIG. 3A, locate the lenticular screen by controlling an arm moving the lenticular screen into the proper location over the folding card using the register mark using machine vision at position 3. Ultraviolet flashlamps cure the adhesive glue. The finished folding car then progresses to the left along the conveyor belt.

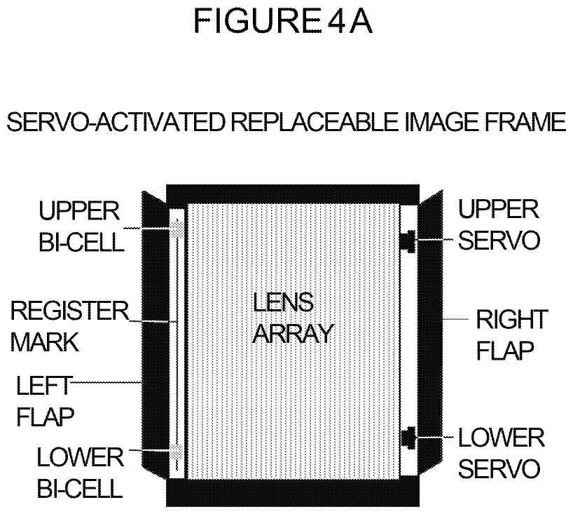

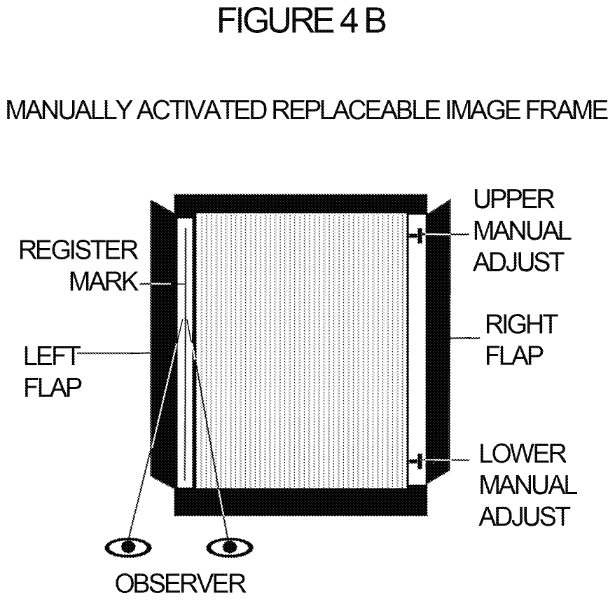

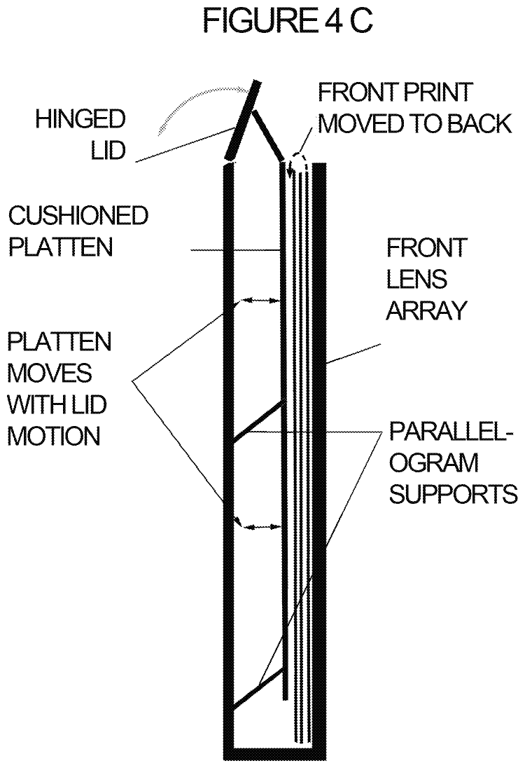

FIG. 4A shows a replaceable-image picture frame that automatically aligns a print with its overlaying lens array, in which two optical bi-cells are fixed, at either end of one side of a rectangular array and detect corresponding register marks on the printed image underneath. These register marks are located outside the printed image-area, at an exact distance from it, and drive two servo-driven linear actuators, which move the planar array about its z-axis and along its x-axis, such that the printed register-mark lies exactly between the two halves of each bi-cell, ensuring perfect alignment of the printed image with the y-axis of the lens array. Also shown in FIG. 4B is a user-operated frame which allows the user to observe a register mark and adjust it via two manual adjustment devices to achieve alignment.

FIG. 4C is a side view of a rectangular box, with a planar lens array on the outer face, behind which a print is pressed against it by a flat, cushioned platen on a parallel plane. The top side of the box is a flap, hinged at the back, and which when opened, allows changing of the print from front to back. This top flap is also hinged to the top of the cushioned platen, and by means of two or more flaps inside the box which are parallel to the hinged top, creates a hinged parallelogram which presses the cushioned platen against the lens array when the top flap is closed. When opened, the parallelogram-hinged platen moves backward from the lens array, allowing the printed image to be changed. It is also possible to have a stack of prints inside the box, which can be changed by moving the print currently on display to the back of the stack when the box is opened, displaying the next print in the stack when closed again as shown in FIG. 4A.

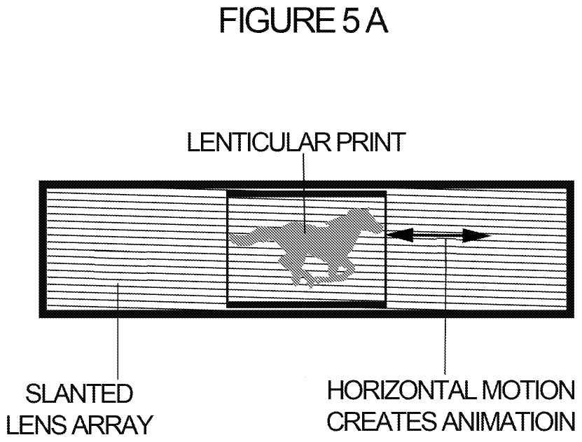

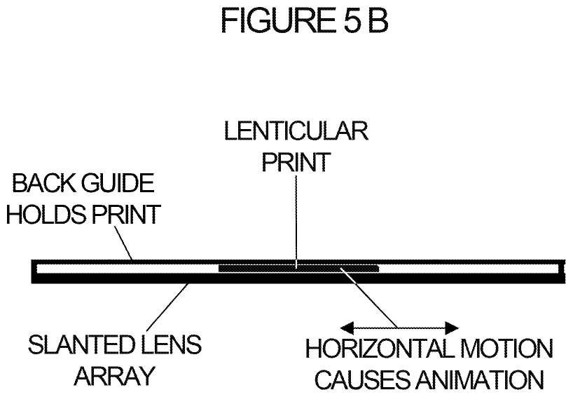

FIG. 5A and FIG. 5B show a horizontally oriented, continuous array of lenses or slits which are substantially horizontal, but with a slight tilt angle contained within a horizontal frame, such that the lenses are vertically displaced by one or more lens widths along their entire length, which is two or more times wider than an identically pitched and tilted lenticular image, which rides along the horizontal frame so as to maintain a perfectly parallel, horizontal motion, such that when reciprocal horizontal motion occurs between the image and the lens, the image seems to change or animate.

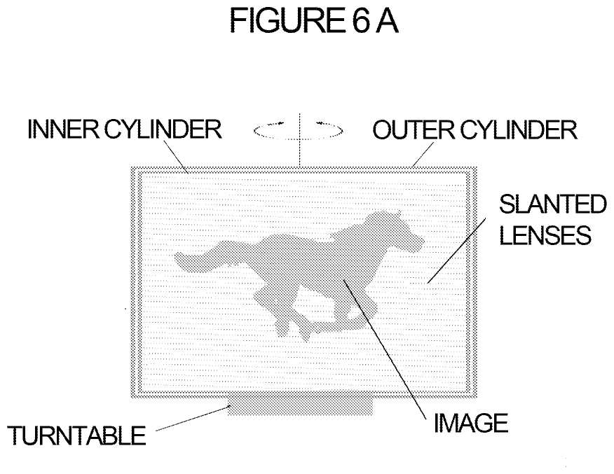

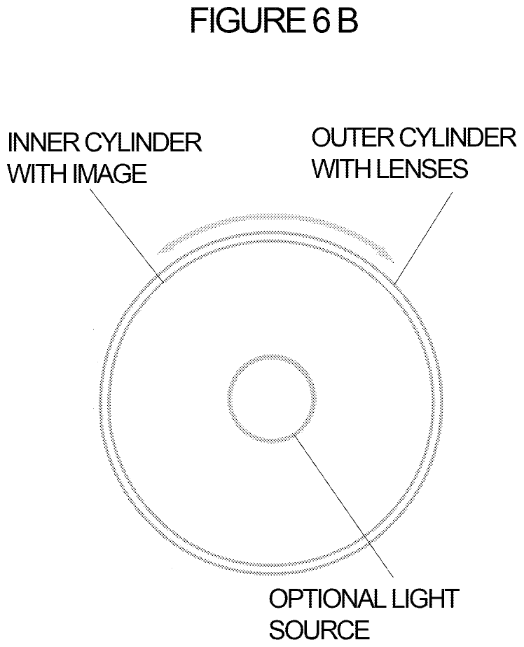

FIG. 6A and FIG. 6B show a cylindrical lenticular lens array surrounding a second, inner cylinder with a printed image at the focal point of the outer lenses, which are substantially horizontal, but with a slight tilt or incline angle. The continuous lenses are at the same very slight tilt angle as that of the interleaved image lines in the image media, causing an image printed on the inner cylinder to animate when the outer cylinder is turned around it, or, if the inner cylinder is turned, and the outer cylinder is still, the animating image will seem to revolve within.

The invention provides a guiding arrangement. In another preferred embodiment of keeping alignment between print and lens array as relative motion occurs, a lens array is guided by interlocking grooves and ridges made of a low-friction material such as Teflon, in order that they may grip each other with no play, or hysteresis. If the materials are not low-friction, then there must be some amount of clearance so that they move freely. In this case, in order to minimize hysteresis, a slight spring-force may be exerted on the moving component from one side, pressing it gently against a straight edge on its opposing side. Both the spring, and the opposite side's straight edge, only contact their respective components with as small an area of contact as possible to further reduce friction.

The invention provides a critical alignment between lens array and print. An embodiment for critical alignment of parallelism between a lenticular print and its overlaying lenticular lens array uses optical sensors or a video camera to monitor a register mark on the lenticular print through the overlaying lens array. The sensor may be made to slide and change position with respect to the array, thereby detecting the register mark through the array from a different angle, and thus viewing a different area of the print under the lenses of the array, or the assembly of print and overlaying lens array may move with respect to the sensor, thus effectively changing its point of view. As the point of view changes, the register mark, which may be a one or more lens widths wide, near the edge of the array and out of the image area, is made such that, when aligned, it seems to move, and/or get brighter or darker along its entire length evenly, if it is exactly aligned with the array, whereas if not aligned, will seem to move and/or get brighter or darker from one side of its length to the other.

The invention provides a replaceable-image picture frame, which automatically aligns a print with its overlaying lens array, in which two optical bi-cells are fixed, at either end of one side of a rectangular array and detect corresponding register marks on the printed image underneath. These register marks are located outside the printed image-area, at an exact distance from it, and drive two servo-driven linear actuators, which move the planar array about its z-axis and along its x-axis, such that the printed register-mark lies exactly between the two halves of each bi-cell, ensuring perfect alignment of the printed image with the y-axis of the lens array.

Such a replaceable-image picture frame could be constructed as a rectangular box, with a planar lens array on the outer face, behind which a print is pressed against it by a flat, cushioned platen on a parallel plane. The top side of the box is a flap, hinged at the back, and which when opened from front to back, allows changing of the print. This top flap is also hinged to the top of the cushioned platen, and by means of two or more flaps inside the box which are parallel to the hinged top, creates a hinged parallelogram which presses the cushioned platen against the lens array when the top flap is closed. When opened, the parallelogram-hinged platen moves backward from the lens array, allowing the printed image to be changed. It is also possible to have a stack of prints inside the box, which can be changed by moving the print currently on display to the back of the stack when the box is opened, displaying the next print in the stack when closed again. Such a changing display could be used as a calendar among other uses.

The invention provides a user-operated replaceable-image picture frame. In an embodiment of a replaceable-image picture frame, the register mark can be printed as a line parallel to one side of the print, such that one side of the frame's front face can be a hinged flap, which may be opened for an observer to see the register line through the lens array, and one or two manually operated motion devices, which can also be hidden under part of the frame, can be used to move the lens array or the printed image so that the register line shows alignment between the array and the print.

The invention provides a cylindrical animation display with little or no blurring. Here a cylindrical lenticular lens array surrounds a second, inner cylinder slightly smaller in diameter with a printed image at the focal point of the outer lenses, which, unlike a vertical lens cylinder type of display, are substantially horizontal, but with a slight tilt. The continuous lenses are at the same very slight tilt as that of the interleaved image lines, such that, with the inner cylinder held still, rotation of the outer, lensed cylinder, will cause the lenses to be slowly displaced vertically, causing animation of the inner image without any substantial blurring, because the tilt of the lenses is not enough to enable binocular vision. This will cause an image printed on the inner cylinder to animate when the outer cylinder is turned around it, or, if the inner cylinder is turned, and the outer cylinder is still, the animated image will seem to revolve within.

The invention provides an alignment method for folding card manufacture. Here sensor-driven servo actuators are employed in the manufacture of a folding card, which causes an image- bearing flap, which is narrower than the bottom flap of the card, to slide between an overlaying lens array and the card's bottom flap. The lens array is wider than the image flap but not wider than the bottom flap, and on the lens array areas outside the image flap, an ultraviolet (UV) adhesive is applied. An optical sensor detects a register mark adjacent to the image area through a portion of the lens array and when a robotic assembly positions the lens array over the image such that the mark shows perfect alignment, an ultraviolet (UV) light source cures the adhesive. The bottom flap is subsequently covered by an envelope covering all its operational mechanisms, and showing only the image area through a window.

Although several embodiments have been shown and described, the invention is not limited to these embodiments, and the scope of the invention is determined only by the following claims.

1. The method of making a lenticular lens array image display, comprising:
providing a sheet of a certain width with pre-cut flap sections along its length including an image flap, an inner top flap hinged to the image flap, an outer top flap hinged to the inner top flap and a bottom flap hinged to the outer top flap;
wherein the image flap contains an image area and a register mark in a strip extending along the width of the image flap;
wherein the bottom flap contains a lenticular lens array and having adhesive strip areas at the peripheral edges;
folding the image flap onto the inner top flap;
folding the outer top flap onto the inner top flap;
folding the bottom flap onto the outer top flap so that the image flap overlays the bottom flap; and
locating a lenticular lens array onto the bottom flap, aligning it with the register mark on the image flap, and adhering the lenticular lens array along edges corresponding to the adhesive strip areas whereby the lenticular lens array covers the image area, but wherein the image flap slides under the lenticular lens array when the inner and outer top faps hinges on the bottom flap to effect relative motion of the image area and lenticular lens array.

2. The method of claim 1, wherein the width of the image flap is less than the certain width of the inner top flap.

3. The method of claim 1, wherein the width of the lenticular lens array being about the same width as the image flap.

4. The method of claim 1, further including providing punch out flaps at edges of the bottom flap for overlaying and aligning the image flap when the image flap slides under the lenticular lens array.

5. The method of claim 1, further including a wrap-around flap hinged to the bottom flap which covers the bottom flap but which defined central opening enabling viewing of the image area through the lenticular lens array.

6. The method of claim 1, wherein the step of locating a lenticular lens array onto the bottom flap comprises:
lifting a lenticular lens array from a supply stack of lenticular lens arrays;
applying adhesive to the edges of the lenticular lens array;
aligning the lenticular lens array onto the bottom flap using the register mark and mounting the lenticular lens array onto the bottom flap; and
curing the adhesive

7. The method of claim 1, wherein the step of locating the lenticular lens array onto the bottom flap and aligning it with the register mark on the image flap includes using optical sensors which detect the position of the lenticular lens array and move it to obtain alignment.

8. The method of claim 7, wherein the step of locating a lenticular lens array onto the bottom flap comprises lifting a lenticular lens array using a suction cup.

9. The method of claim 6, wherein the step of locating a lenticular lens array onto the bottom flap comprises using an arm movable about from a first rotational position where it lifts a lenticular lens array from a supply stack, to a second position wherein the lenticular lens array receives adhesive, to a third position wherein the lenticular lens array is aligned with the bottom flap.

10. The method of claim 9, wherein the arm rotates around a central axis to the first, second, and third positions.

11. The method of claim 6, wherein the step of curing includes curing with an ultraviolet (UV) curing flash lamp.

12. The method of claim 9 wherein the first, second and third positions are along a linear path.

13. A lenticular lens array image display made according to the method of claim 1.

14. A lenticular lens array image display, comprising:
a housing with a back, bottom, front with lenticular lens array and a top hinged lid to which it is hinged to an upper part of the back, a platen attached to the lid and hinged by connected to the back, and defining an image medium storage region between the platen and front, whereby movement of the top hinged lid will cause the platen to move towards and away from the front with the lenticular lens array.

15. The lenticular lens array image display of claim 14, wherein the image medium storage region has a size to hold a plurality of image media plates.

16. The lenticular lens array image display of claim 14, further including manual adjustment knobs which are operative to shift an image media plate in the image medium storage region and align it using a register mark on a peripheral edge of the image media plate so that an image stored in the image media plate will be aligned with the lenticular lens array.

17. The lenticular lens array display of claim 16, further including servo adjust mechanisms and optical cells which detect the position of the image media plate relative to the lenticular lens array using a register mark, and shift the image media plate to be aligned with the lenticular lens array using the servo adjust mechanisms.

18. A lenticular lens array image display, comprising:
an inner cylinder containing lenticular images around the inner cylinder an outer cylinder of lenticular lens array arranged with lenses formed generally horizontally but at inclined angles and enclosing the inner cylinder, whereby rotation of inner and outer cylinders relative to each other will enable display of an animated image when viewed from a perspective outside the outer cylinder.

19. The lenticular lens array image display of claim 18, further including a light source located inside the inner cylinder.

20. A lenticular lens array image display, comprising a generally rectangular frame having a front, back, and bottom and defining slot for receiving an image plate containing a lenticular viewable image, and a lenticular lens array on the front of the frame, the lens array having a lenticular lens array which is slanted relative to the rectangular frame, whereby movement of the image plate from side to side within the frame will cause display of an animated image viewed from the front of the frame.

21. The lenticular lens array image display of claim 20 wherein the lenticular lens array has one of slots and ridges, and wherein the image plate has the other of slots or ridges to guide the lenticular lens array relative to the image plate.

22. The lenticular lens array of claim 21 wherein at least one of the slots and ridges are made of low-friction material.

23. A lenticular lens array and image display, comprising:
an image plate media for containing a plurality of interleaved lenticular images; and a
lenticular lens array which overlays the image plate media, whereby relative motion of
the image plate media and lenticular lens array enables animated images to be seen viewed through the lenticular lens array;
wherein at least of the image plate media and lenticular lens array includes a registration mark to provide alignment of the image plate media with the lenticular lens array.

24. The lenticular lens array and image display of claim 23, wherein the registration mark is in the form of a registration strip on the image plate media.
